(19) United States
(12) Patent Application Publication
(10) Pub. No.: US 2011/0295526 A1
(43) Pub. Date: Dec. 1, 2011

(54) Method for Determining a Change of Vortex Geometry

(76) Inventor: Berend van der Wall, Braunschweig (DE)

(21) Appl. No.: 13/116,452

(22) Filed: May 26, 2011

(30) Foreign Application Priority Data
May 27, 2010 (DE) 10 2010 021 672.0

(51) Int. Cl. G06F 19/00

(52) U.S. Cl. 702/50

(57) ABSTRACT

The invention relates to an approximation method for determining a change in vortex geometry at a rotor consisting of several rotor blades, where the rotor is located above the fuselage, with the steps:
Determining a non-linear vertical velocity field, induced by the fuselage, by means of an analytic function of radial (polynomial approach) and azimuthal (Fourier series) in the rotor plane and
calculating the vortex geometry change as a function of the induced.

The invention relates to a method for determining a change in vortex geometry of rotor vortexes formed at a rotor consisting of several rotor blades, where the rotor is located above the fuselage. The invention also relates to a method for determining vortex geometry. The invention also relates to a computer program to do so.

In almost all areas of development it has become naturally to test the components and devices to be developed by using simulation programs, at least virtually under designed real conditions, to get data on the behaviour of newly constructed components beforehand. These components are usually designed using a CAD program on the computer which is using the simulation software to simulate the behavior of the device in use. The findings also facilitate the design and reduce to a considerable extent the cost of the component, since design flaws can be detected early on which would otherwise only be detected at a much later stage of development, e.g. while the component is tested physically under real conditions. Therefore, the simulation of technical components has a direct impact on technical development and design of these components.

In the development of rotary-wing aircraft, especially in case of helicopters, simulation software is increasingly used to simulate the behavior of a helicopter in flight. Especially for critical parts such as fuselage and rotor simulation is extremely useful, because this way it can be determined at an early stage which characteristics the corresponding component does have under the given boundary conditions and to what stresses the component is exposed to statically and dynamically.

It is, for instance, in the development of helicopter rotors in particular, a requirement that they do not exceed, under the given conditions a certain noise level. Especially in approach for landing, certain noise level limits may not be exceeded. For this reason it is useful—in order to reduce development costs—if the acoustics of the helicopter and its rotor is first simulated to find out if a developed rotor does meet requirements with respect to noise levels. Otherwise, a rotor would have to be constructed and then tested under real conditions which would increase development costs and development time. Additionally, other parameters such as performance, dynamics, aerodynamics and aeroelasticity of such a rotor can be simulated beforehand.

With regard to the acoustics of a helicopter rotor, the vortices at the rotor blade tips, in particular, play a major role. Each rotor of a rotorcraft consists—as is well known—of several rotor blades which rotate with the respective velocity or speed of rotation about an axis on which they are arranged in a fixed or hinged manner. Because of the radial and azimuthal distribution of lift of the rotor blades air vortexes develop at the rotor blade tips (inside and outside and possibly between), which influence to a large degree the acoustic behavior of the entire rotor. In general, one can say that the noise level is higher, the closer a rotor blade moves past an air vortex generated by the rotor blade.

During a revolution, the individual rotor blades on a rotor have different angles, i.e. a backward-pointing blade is assigned an angle of 0°, while a forward-pointing blade has an azimuthal angle of 180°. The respective vertical positions of the rotor blades left and right of the fuselage have 90°, respectively 270°. In particular, those vortexes which are produced in a range from 90° to 270° before the rotor head, have a substantial influence on the acoustics of the rotor, since these vortexes are carried through the rotor plane in an assumed air velocity. The vortexes generated between 270° and 90° behind the rotor head, however, have no effect on the acoustics, because they are carried immediately behind the rotor plane assuming a forward flight speed and so can no longer be “cut” by trailing rotor blades. The lift of the rotor leads to a downwash zone in the rotor plane which moves the moving vortexes downward.

It should be noted, the faster the helicopter is flying, the less trailing blades can cut the vortex, as it is carried with a correspondingly higher induced horizontal velocity by the rotor plane. However, in slow landing approach the generated vortexes are often cut by the trailing rotor blades, as these vortexes move very slowly through the rotor plane towards the back. Especially in landing approach, another fact makes it difficult, as the generated vortexes are not pushed downward by the air flow through the rotor, as the vortexes have a tendency to sink slowly as a result of the lowering velocity of the helicopter.

Therefore, to simulate the acoustics of a rotor helicopter it is essential that at least the position of the vortexes or the entire vortex system under the given conditions is predictable, in order to calculate the position of the rotor blades relative to the individual vortexes and thus to calculate the acoustics. The problem is, that there is no analytical solution for it, as the geometry of the vortex system depends on many parameters, specifically, for example on the operating parameters such as flight speed, angle of the rotor in space, generated rotor thrust, rotor speed and many more. Additionally, the radial distribution of lift also has influence on the position of vortexes in space.

For the calculation of the vortex geometry and thus simulation of the acoustics there are two calculation methods known from current state of the art. In case of one of the methods it is the so-called Free-Wake method where the full equation of motion of the vortex system is solved, which requires a significant computational effort. The other method is known as the Prescribed Wake method where the vortex geometry is calculated approximately under the assumption of constant external operating conditions; resulting in significant reduction in calculation effort.

In case of the aforementioned free-wake method, the full equation of motion of the vortex system is solved by discretization of the entire system into several thousand individual vortex segments and using a numerical integration of the equation of motion in time, where the geometry is preserved in space and time. This requires a considerable computation effort which is shown in the following example: In case of a four-bladed rotor one needs for the calculation of rotor acoustics a radial discretization of the rotor blades in at least 20 blade segments which means that for each rotor blade there are 21 vortexes at the element boundaries in the wake of each blade. For the entire rotor this means 84 vortex elements (21 element boundaries×4 blades). Furthermore, at least 72 vortex segments must be taken into account per revolution which equates to an arc length of 5°. This results in 6048 vortex segments to be examined per revolution of the entire rotor plane. To obtain the vortex induction at the rotor with sufficient accuracy, one must obtain the vortex system for about five complete revolutions behind each rotor blade, resulting in a total of 30240 vortex segments. The numerical integration for acoustic calculations must be done in time steps of more than 1 degree rotor angle, i.e. 360 time steps per revolution and for a convergent solution at least five revolutions are necessary. This results in 1800 time steps. In each of these time steps, the interaction of each of the 30240 vortex segments for all vortex ends, so called vertex, must be determined. In total, there are at least 1800 time-steps×30240 vortexes×30240 vertexes, a total of 1.7×10¹¹ operations to be carried out in order to fully determine the geometry of the vortex system. Therefore, this requires very extensive computing power.

Due to this, there have been efforts earlier to calculate the vortex geometry at least approximately which would mean a considerable reduction in computation time. In the approximate calculation certain operating conditions are specified as constant which ultimately does not require solving the equation of motion of the vortex system, thus reducing the computational time required by many decimal powers. The flight speed, the inclination of the rotor in space, the generated rotor thrust, the rotor speed and the blade connection, for example, are used as constant external operating conditions and operating parameters. An overview of currently known Prescribed-Wake method can be found, for instance, in B. G. van der Wall: “The influence of active blade control on the vortex motion in the wake of helicopter rotors”, DLR-FB 1999-34 (1999). The key advantage of the Prescribed-Wake method is that, assuming a simple analytical description of the distribution of the induced velocity distribution in the rotor plane and behind, the vortex geometry can be calculated analytically.

Disadvantage of the above state of the art Prescribed Wake method is the fact that this method uses a static lift distribution in the rotor plane. This results, ultimately, in a more or less a static vortex position change during the simulation, the external factors that change sustainably the vortex position, are ignored. Such factors can ultimately only be taken into account in the Free-Wake method; however, it does not permit a fast solution. Such a determining factor, for instance, is the flow around the fuselage during forward flight movement that can have an influence on the vortex geometry.

It is therefore an object of the present invention to provide a method with which the disadvantages of the current state of the art can be overcome in order to carry out an approximate calculation of the vortex geometry on rotors.

The task or problem is solved with the aforementioned method by use of the following steps:
Determining a non-linear vertical velocity field, induced by the fuselage, by means of an analytic function of radial (polynomial approach) and azimuthal (Fourier series) in the rotor plane and
calculating the vortex geometry change as a function of the induced vertical velocity field.

This makes it possible to take into account—in addition to the already known Prescribed Wake method, which permits an approximate calculation of the vortex geometry—vortex position changes as they arise because of the flow around the fuselage during forward flight movement in order to improve the approximate result calculated from the Prescribed-Wake method. Although, the maximum distortion due to the flow around the fuselage accounts for only about 5% of the rotor radius which appears at first glance not much, but in view of the problem of rotor blade vortex interaction it can be of considerable importance, since the vortex core radii are in size also only 5% of the profile depth which in turn are a twentieth part of the rotor radii. Insofar, already known Prescribed-Wake methods can be improved considerably in their accuracy.

For this purpose, the invention currently under consideration proposes that at first a generally radial and azimuthal non-linear vertical velocity field in the rotor plane is determined which results from the flow around the vehicle fuselage during forward flight speed. Due to the flow around the hull and due to flight speed in the front area of the rotor an upwash zone is generated which deflects the vortex system upwards, and in the area behind the rotor head it is a downwash zone, leading in turn to a lowering vortex system. From this vertical velocity field, induced by the vehicle fuselage, in the rotor plane, the respective deflection of the vortex geometry due to the flow in the rotor plane can be determined so that the respective geometry change can be calculated for the entire rotor plane. The underlying simplicity of the invention is to describe by analytical functions the non-linear velocity field generated and induced by the helicopter body so that the vortex geometry change can be calculated analytically without numerical integration.

Knowing about this change in geometry of the rotor vortexes due to an induced up or down wash zone one can now adjust the classical Prescribed-Wake-method to the effect that this vortex geometry change is taken into account based on the flow around the body. The required additional effort to the classic Prescribed-Wake method is negligible.

Preferably, the indicated vertical velocity field is determined by using a CFD method (Computational Fluid Dynamics). CFD methods are known from computational fluid dynamics with the aim of trying to solve fluid mechanical problems with approximate numerical methods. In particular, finite volume methods based on the Navier-Stokes equations or the Euler equations can advantageously be applied. But even with use of the so-called panel method, the induction in the rotor plane can be calculated.

In order to obtain a very accurate result, it is particularly advantageous if the induced vertical velocities at the rotor plane are measured as a function of an individual body shape of the helicopter body. Since the nature of the flow around the helicopter body is very dependent on the actual body shape, this additional effort might be worth it, if by using such approximate calculation, the result is more accurate.

It has been found that in a usual extension of the body the flow effects at the rotor plane in an area up to about 50% of the rotor radius are clearly felt and after that they drop non-linear. Therefore, it may be advantageous in many cases, to adopt a generic body shape for the flow effects to determine the induced vertical velocity field. The use of a generic helicopter body releases one from the need of understanding the examined individual fuselage and delivers in many cases a useful result.

In the incompressible area, i.e. flight mach number of M<0.3, which usually is given in case of helicopters, as their maximum flight mach number is at M=0.25 or less, the induced vertical speed field at the rotor plane and their amplitudes are directly proportional to the flight speed of the fuselage.

Furthermore, it was also found that in addition to flight speed the inclination of the body, such as the so-called pitch axis, has an influence on the induced vertical velocity field in the rotor plane, for which it is particularly advantageous if it is taken into account. Particularly in helicopters one finds during forward flight movement different angles of the vehicle fuselage compared to the flight level.

The radial distribution of the induced vertical velocity field can take place depending on a radial distribution function, such as a quadratic or higher polynomial distribution function. Preferably, the azimuthal distribution of the induced vertical velocity field is determined as a function of a Fourier series.

The aforementioned task is also solved by a computer program with program code means adapted to carry out the method.

The invention is illustrated exemplary in the accompanying drawings. The following is depicted:

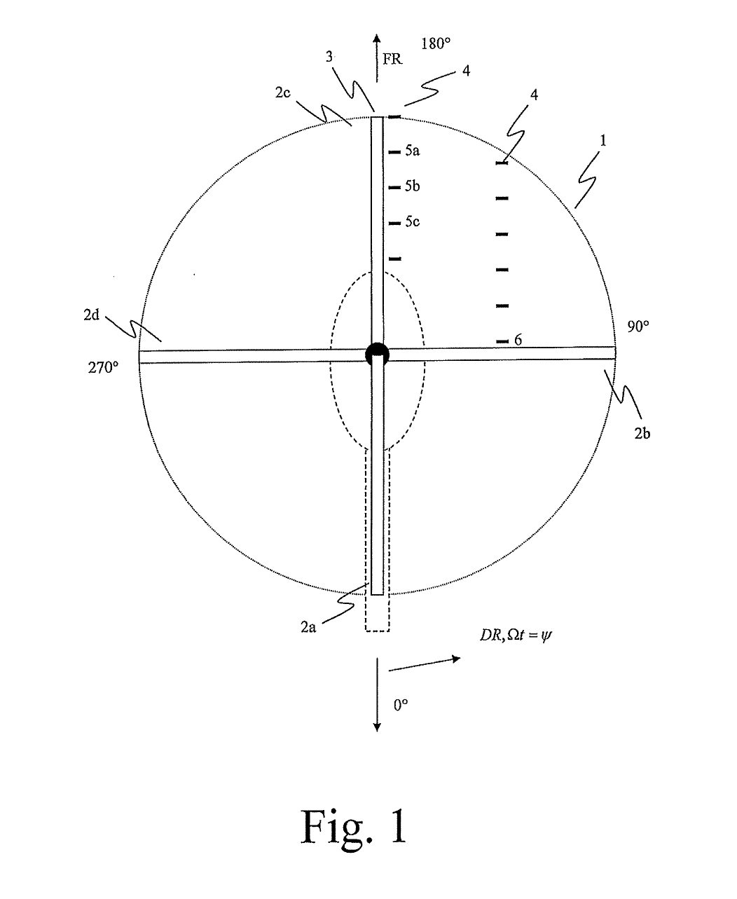

FIG. 1—simplified schematic diagram of the vortex distribution;

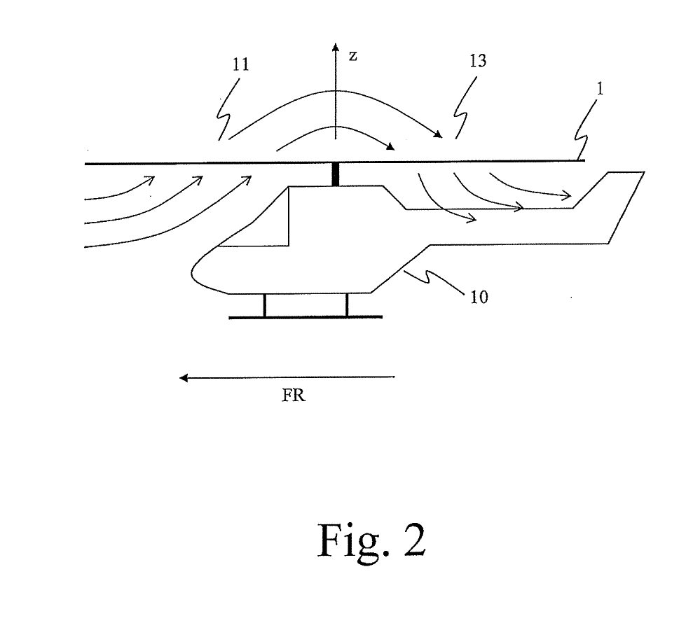

FIG. 2—sketch of the flow around the fuselage forward flight in the median section of FIG. 1, and

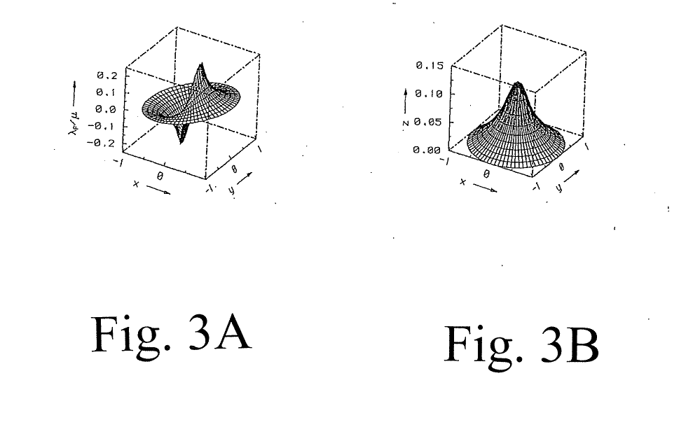

FIG. 3—representation of an induced velocity field and the associated deformation of the vortex geometry.

FIG. 1 shows a representation of a vortex distribution of a helicopter rotor 1, which consists of four blades 2a through 2d. The rotor rotates in a rotational direction DR which is marked by a corresponding arrow. The rotor 1 has four rotor blades 2a through 2d, which in the embodiment FIG. 1 do have a particular orientation. Thus, the orientation of the rotor blade 2a is generally referred to as 0°, while the rotor blade 2c pointing in flight direction does have an angle of rotation of 180°. Therefore, rotor blade 2b with 90° and 2d with 270° are both directly perpendicular to the direction of flight. At the rotor blade tips 3 vortexes 4 are generated during the rotation which move due to flight speed in the direction of FR and over time through the rotor plane. This is illustrated with the vortexes 5a through 5c which are shown at different positions at different times. If a rotor blade such as the rotor blade 2b hits such a vortex in the rotor plane, for instance vortex 6 it will have an enormous impact on the noise development of the rotor 1, and it should be stated that the closer the corresponding rotor blade is passing the vortex the greater the noise.

FIG. 2 shows a schematic representation of the flow around the fuselage in a forward direction of flight FR. Due to the fuselage shape of the fuselage 10 an upwash zone 11 is generated in front of the rotor head which leads to an upward deflection of the vortex system generated in the rotor. On the other hand, in the back area of the rotor head a downwash zone 13 is generated which leads to a lowering of the vortex system. By this upwash zone 11 or downwash zone 13 during forward flight in direction FR the individual vortexes at the rotor blade tips are deflected accordingly which can be represented using an induced vertical velocity field.

The following example shows the implementation of the inventive method. By use of a panel method, at first, the induced velocities vᵢ/V_{∞} are calculated in the rotor plane. This velocity field is proportional to flight speed V_{∞} and thus the ratio vᵢ/V_{∞} independent of airspeed, but depending on the angle of the fuselage. This induced velocity field is in the radial direction can be represented by higher order polynomials (r is related to the rotor radius dimensionless radial coordinate, as well as x, y and z, corresponding to the non-dimensional Cartesian coordinates system coordinates), while their coefficients cₙⱼ(α) again are represented by polynomials in angle of attack of the fuselage α. In circumferential direction for each polynomial φᵢ(t) a Fourier series qᵢ(t) is used so that the following results:

$$\begin{matrix}\frac{{v}_{i}}{{V}_{∞}} = {\sum }_{n = 1}^{N} {φ}_{n} ( r , α ) {q}_{n} ( t ) N \geq n & ( 1 ) \\ {φ}_{n} ( r , α ) = {\sum }_{j = 0}^{J} {c}_{nj} ( α ) {r}^{j} \vert J \vert \geq j und J ∈ N & ( 2 ) \\ r = \sqrt{{x}^{2} + {y}^{2}} & ( 3 ) \\ {c}_{nj} ( α ) = {\sum }_{l = 0}^{L} {d}_{njl} {α}^{l} L \geq l & ( 4 ) \\ {q}_{n} ( t ) = {\sum }_{k = 0}^{K} {q}_{nk} cos ( k ψ t - {ψ}_{nk} ) K \geq k & ( 5 )\end{matrix}$$

Due to the lateral symmetry of the fuselage and its induced velocity field all are phase angles ψₙₖ=0 and only the cos-terms remain. For the representation of the method it is sufficient to use a generic fuselage and to use the resulting velocity field with reduced order of the trial function. for this purpose an influencing radius rᵢ is defined, e.g. which can be rᵢ=0.2 with todays rotors which characterizes the profiled blade start. Outside which the radial shape trial function decreases proportionally with 1/r, and within it (in the rotor center beginning with 0) it increases linearly. While this is only an approximation to the actual non-linear induced velocity fields, but it describes its characteristics accurately enough. The radial trial function is thus given by

$$\begin{matrix}φ ( r ) = {c}_{0} + {c}_{1} \frac{{r}_{i}}{r} & r > {r}_{i} \\ = {c}_{0} + {c}_{1} \frac{r}{{r}_{i }} & r < {r}_{i}\end{matrix} \qquad \begin{matrix}( 6 ) \\ \\ ( 7 )\end{matrix}$$

which represents the exponentially falling induction effect with the radius. For simplicity c₀=0 and c₁=1 are set. c₀=0 can be justified with the fact that due to the missing ascending force of the fuselage as much induction is generated upwards in front of the center of the rotor as downwards behind it. In the circumferential direction, for purposes of simplicity, only the first harmonic is used, so that

$$q ( ψ ) = cos ψ = \frac{x}{r} = \frac{x}{\sqrt{{x}^{2} + {y}^{2}}} \qquad ( 8 )$$

A function of the angle of attack angle is to be omitted because it modifies only the value c₁. This results in

$$\begin{matrix}\begin{matrix}\frac{{v}_{i}}{V ∞} = \frac{{v}_{i} / ( Ω R )}{{V}_{∞} / ( Ω R )} = \frac{{λ}_{f}}{μ} = φ ( r ) q ( ϕ ) = {r}_{i} \frac{x}{{r}^{2}} = {r}_{i} \frac{x}{{x}^{2} + {y}^{2}} & r > {r}_{i}\end{matrix} & ( 9 ) \\ \begin{matrix}\frac{{v}_{i}}{{V}_{∞}} = \frac{x}{{r}_{i}} & r < {r}_{i}\end{matrix} & ( 10 )\end{matrix}$$

Using equation (6) through (8) the induced vertical velocity field represented in FIG. 3a), for instance, can be calculated, where a positive displacement amplitude describes a negatively induced velocity (i.e. downward). From this the standardized derived vertical vortex changes can be derived, resulting in a deformation of the vortex geometry, as shown in FIG. 3b. The calculation of the vertical position of a vortex element that results from y=r sin ψ for 90°<ψ<270° and thus migrates through this velocity field is done by integrating along x from the origin point in xₐ at x=xₐ=−\sqrt{1−y²} up to point x.

$$\begin{matrix}z = \frac{1}{R} {\int }_{{x}_{a}}^{x} {v}_{i} ( x ) d t = {\int }_{{x}_{a}}^{x} \frac{{λ}_{f} ( x )}{μ} d x & ( 11 ) \\ \begin{matrix}= - \frac{{r}_{i}}{2} ln ( {r}^{2} ) & {r}^{2} > {r}_{i}^{2}\end{matrix} & ( 12 ) \\ \begin{matrix}= - \frac{{r}_{i}}{2} ( ln ( {r}_{i}^{2} ) + \frac{{r}^{2}}{{r}_{i}^{2}} - 1 ) & {r}^{2} < {r}_{i}^{2}\end{matrix} & ( 13 )\end{matrix}$$

The deformation is not a function of flight speed any more. FIG. 3b shows the calculated deformation of the vortex geometry. As can be seen, as represented in FIG. 3b), the largest deformation is at the rotor head center in the line of symmetry. The deformation at the outer edge of the rotor plane is gone, which is due to the fact that the mean value of the induced velocities in a section y=const (because of c₀=0) is zero everywhere, so everything that exists as upwash in front of the center of the rotor is compensated by the downwash behind it.

1. Method for determining a change in vortex geometry of rotor vortexes formed at a rotor consisting of several rotor blades, where the rotor is located above the fuselage, with the steps:
Determining a non-linear vertical velocity field, induced by the fuselage, by means of an analytic function of radial (polynomial approach) and azimuthal (Fourier series) in the rotor plane and
calculating the vortex geometry change as a function of the induced vertical velocity field.

2. Method in accordance with claim 1, characterized by calculating the vortex geometry change in the form of vertical displacements of the rotor vortexes.

3. Method in accordance with claim 1, characterized by determining the induced vertical velocity field by a CFD method (Computational Fluid Dynamics), in particular by means of finite volume methods, or through a panel method (potential theory).

4. Method in accordance with claim 1, characterized by determining the induced vertical velocity field as a function of an individual fuselage shape of the fuselage.

5. Method in accordance with claim 1, characterized by determining the induced vertical velocity field as a function of a generic fuselage model of the fuselage.

6. Method based on claim 1, characterized by determining the induced vertical velocity field as a function of the speed of the fuselage.

7. Method based claim 1, characterized by determining the induced vertical velocity field as a function of the angle of attack of the fuselage.

8. Method based on claim 1, characterized by determining a radial distribution of the induced vertical velocity field as a function of a radial distribution function.

9. Method based on claim 1, characterized by determining an azimuthal distribution of the induced vertical velocity field in form of a Fourier series.

10. Method for determining a vortex geometry at a rotor consisting of several rotor blades, where at first in dependence of assumed constant operating parameters of the rotor a static ascending force distribution of the rotating rotor is approximately calculated, and the vortex geometry as a function of the static ascending force distribution and the vortex geometry change of the rotor vortex in accordance with claim 1.

11. Computer program with program code means adapted to implement the method according to claim 1 while the computer program is executed on a data processing system.

12. Computer program with program code means, stored on a machine readable media, adapted to implement the method according to claim 1 while the computer program is executed on a data processing system.
